(19) United States
(12) Patent Application Publication
(10) Pub. No.: US 2006/0206340 A1
(43) Pub. Date: Sep. 14, 2006

(54) Methods for synchronous and asynchronous voice-enabled content selection and content synchronization for a mobile or fixed multimedia station

(76) Inventors: Marja Marketta Silvera, Orinda, CA (US); Leo Chiu, Daly City, CA (US)

Correspondence Address: CENTRAL COAST PATENT AGENCY, PO BOX 187, AROMAS, CA, 95004, US

(21) Appl. No.: 11/359,660

(22) Filed: Feb. 21, 2006

Related U.S. Application Data
(63) Continuation-in-part of application No. 11/132,805, filed on May 18, 2005.
(60) Provisional application No. 60/660,985, filed on Mar. 11, 2005.
(60) Provisional application No. 60/665,326, filed on Mar. 25, 2005.

(51) Int. Cl. G10L 21/00

(52) U.S. Cl. 704/278

(57) ABSTRACT

A system is provided for enabling voice-enabled selection and execution for playback of media files stored on a media content playback device. The system includes a voice input circuitry and speech recognition module for enabling voice input recognizable on the device as one or more voice commands for task performance; a push-to-talk interface for activating the voice input circuitry and speech recognition module; and a media content synchronization device for maintaining synchronization between stored media content selections and at least one list of grammar sets used for speech recognition by the speech recognition module, the names identifying one or more media content selections currently stored and available for playback on the media content playback device.

### CROSS-REFERENCE TO RELATED APPLICATIONS

The present application is a continuation in part (CIP) to a U.S. patent application Ser. No. 11/132,805 filed on May 18, 2005, which claims priority to a provisional application Ser. No. 60/660,985, filed on Mar. 11, 2005 and a provisional application Ser. No. 60/665,326 filed on Mar. 25, 2005. The above referenced applications are included herein in their entirety at least by reference.

### BACKGROUND OF THE INVENTION

1. Field of the Invention

The present invention is in the field of digital media content storage and retrieval from mobile, storage and playback devices and pertains particularly to a voice recognition command system and method for synchronous and asynchronous selection of media content stored for playback and for synchronization of stored content on a mobile device having a voice enabled command system.

2. Discussion of the State of the Art

The art of digital music and video consumption has, more recently migrated from digital storage of media content typically on mainstream computing devices such as desktop computer systems to storage of content on lighter mobile devices including digital music players like the Rio™MP3 player, Apple Computer's iPod™, and others.

Likewise, devices like the smart phone (third generation cellular phone), personal digital assistants (PDAs), and the like are also capable of storing and playing back digital music and video using playback software adapted for the purpose. Storage capability for these lighter mobile devices has been increased dramatically up to more than one gigabyte of storage space. Such storage capacity enables a user to download and store hundreds or even thousands of media selections on a single playback device.

Currently, the methods used to locate and to play media selections on those mobile devices is to manually locate and play the desired selection or selections through manipulation of some physical indicia such as a media selection button or, perhaps a scrolling wheel. In a case where hundreds or thousands of stored selections are available for playback, navigating to them physically may be, at best, time consuming and frustrating for an average user. Organization techniques such as file system-based storage and labeling may work to lessen manual processing related to content selection, however with many possible choices manual navigation may still be time consuming.

The inventor knows of a system referenced herein as [our docket 8130PA] that provides for a voice-enabled media content navigation system that may be used on a mobile playback device to quickly identify and execute playback of a media selection stored on the device. A system includes a voice input circuitry for inputting voice-based commands into the playback device; codec circuitry for converting voice input from analog content to digital content for speech recognition and for converting voice-located media content to analog content for playback; and a media content synchronization device for maintaining at least one grammar list of names representing media content selections in a current state according to what is currently stored and available for playback on the playback device.

In the above-described system, the mobile device may be a hand-held media player, a cellular telephone, a personal digital assistant, or other electronics devices used to disseminate multimedia audio and audio/visual content, or software programs running on larger systems or sub-systems. Some multimedia-capable devices are also capable of network browsing and telephony communication. Other devices synchronize with a host system such as a personal computer functioning as an end node or target node on a network. Likewise, there are other multimedia capable stations that are embodied as set-top box systems, which are relatively fixed and not easily portable. Some of these system types may also be Web and/or telephony enabled.

It is desired that tasks related to media selection for playback from storage system on a device and synchronization of content stored or available with a directory or library on the device, or off site with respect to a device on a network be streamlined to simplify those processes, including those processes that are voice-enabled. Therefore, what is clearly needed are methods for asynchronously and synchronously interacting with a multimedia device to select content for playback and methods for asynchronously and synchronously interacting with local or remote content storage and delivery systems including content directories for ensuring updated content representation on the device.

### SUMMARY OF THE INVENTION

A system enabling voice-enabled selection and execution for playback of media files stored on a media content playback device has a voice input circuitry and speech recognition module for enabling voice input recognizable on the device as one or more voice commands for task performance, a push-to-talk interface for activating the voice input circuitry and speech recognition module, and a media content synchronization device for maintaining synchronization between stored media content selections and at least one list of grammar sets used for speech recognition by the speech recognition module, the names identifying one or more media content selections currently stored and available for playback on the media content playback device.

In one embodiment, the playback device is a digital media player, a cellular telephone, or a personal digital assistant. In another embodiment, the playback device is a Laptop computer, a digital entertainment system, or a set top box system. In one embodiment, the push-to-talk interface is controlled by physical indicia present on the media content playback device. In another embodiment, a soft switch controls the push-to-talk interface, the soft switch activated from a remote device sharing a network with the media content playback device.

In one embodiment, the names in the grammar list define one or a combination of title, genre, and artist associated with one or more media content selections. In this embodiment, the media content selections are one or a combination of songs and movies. In one embodiment, the media content synchronization device is external from the media content playback device but accessible to the device by a network. In one embodiment, the network shared by the remote device and playback device is one of a wireless network bridged to an Internet network.

According to one aspect of the invention, the system further includes a voice-enabled remote control unit for remotely controlling the media content playback device. In this aspect, the remote unit includes a push-to-talk interface, voice input circuitry, and an analog to digital converter.

In still another aspect, a server node is provided for synchronizing media content between a repository on a media content playback device and a repository located externally from the media content playback device. The server includes a push-to-talk interface for accepting push-to-talk events and for sending push-to-talk events, a multimedia storage library, and a multimedia content synchronizer. In a variation of this aspect, the server is maintained on an Internet network.

In one embodiment, the server node includes a speech application for interacting with callers, the application capable of calling the playback device and issuing synthesized voice commands to the media content playback device. In this embodiment, the call placed through the speech application is a unilateral voice event, the voice synthesized or pre-recorded.

In yet another aspect of the present invention, a media content selection and playback device is provided. The device includes a voice input circuitry for inputting voice commands to the device, a speech recognition module with access to a grammar repository for providing recognition of input voice commands and, a push-to-talk indicia for activating the voice input circuitry and speech recognition module. Depressing the push-to-talk indicia and maintaining the depressed state of the indicia enables voice input and recognition for performing one or more tasks including selecting and playing media content.

In one embodiment, the grammar repository contains at least one list of names defining one or a combination of title, genre, and artist associated with one or more media content selections. In this embodiment, the grammar repository is periodically synchronized with a media content repository, synchronization enabled through voice command delivered through the push-to-talk interface.

According to another aspect of the invention, a method is provided for selecting and playing a media selection on a media playback device. The method includes acts for (a) depressing and holding a push to talk indicia on or associated with the playback device, (b) inputting a voice expression equated to the media selection into voice input circuitry on or associated with the device, (c) recognizing the enunciated expression on the device using voice recognition installed on the device, (d) retrieving and decoding the selected media; and (e) playing the selected media over output speakers on the device. In one aspect, steps (a) and (b) of the method is practiced using a remote control unit sharing a network with the device.

### BRIEF DESCRIPTION OF THE DRAWING FIGURES

FIG. 1 is a block diagram illustrating a media playing device with a manual media content selection system according to prior art.

FIG. 2 is a bloc diagram illustrating voice-enabled media content selection system architecture according to an embodiment of the present invention.

FIG. 3 is a flow chart illustrating steps for synchronizing media with a voice-enabled media server according to an embodiment of the present invention.

FIG. 4 is a flow chart illustrating steps for accessing and playing synchronized media content according to an embodiment of the present invention.

FIG. 5 is a block diagram illustrating a multimedia device with a hard-switched push-to-talk interface according to an embodiment of the present invention.

FIG. 6 is a block diagram illustrating a multimedia device with a remote controlled, soft-switched push-to-talk interface according to an embodiment of the present invention.

FIG. 7 is a block diagram illustrating a multimedia device of FIG. 5 enhanced for remote synchronization according to an embodiment of the present invention.

### DETAILED DESCRIPTION

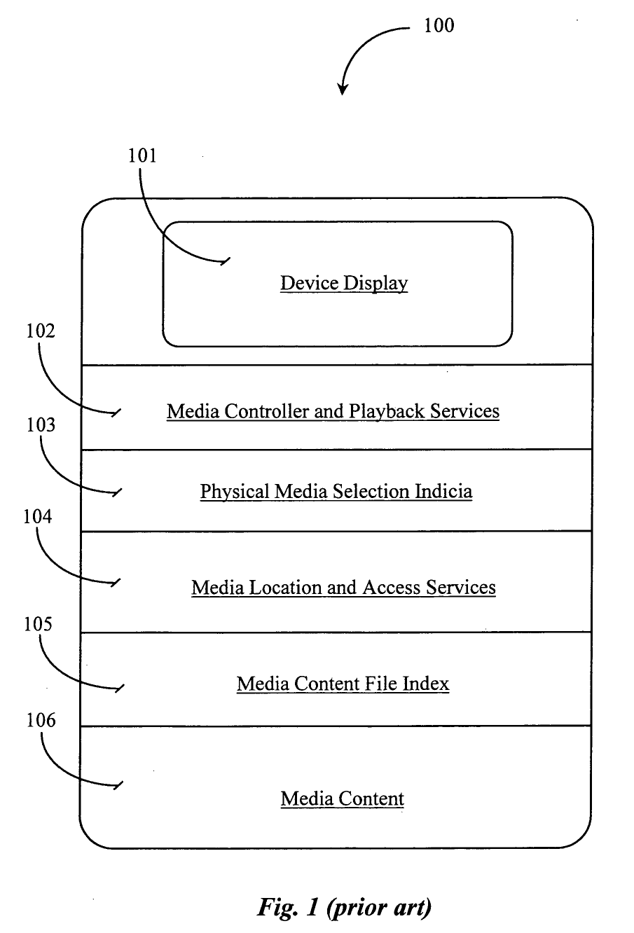

FIG. 1 is a block diagram illustrating a media playing device 100 with a manual media content selection system according to prior art. Media playing device 100 may be typical of many brands of digital media players on the market that are capable of playback of stored media content. Player 100 may be adapted to play either digital audio files and may, in some cases play audio/video files as well. Media player 100 may also represent some devices that are multitasking devices adapted to playback stored media content in addition to other tasks. A cellular telephone capable of download and playback of graphics, audio, and video is an example of such as device.

Device 100 typically has a device display 101 in the form of a light emitting diode (LED) screen or other suitable screen adapted to display content for a user operating the device. In this logical block illustration, the basic functions and services available on device 100 are illustrated herein as a plurality of sections or layers. These include a media controller and media playback services layer 102. The media controller typically controls playback characteristics of the media content and uses a software player for the purpose of executing and playing the digital content.

As described further above, device 100 has a physical media selection layer 103 provided thereto, the layer containing all of the designated indicia available for the purpose of locating, identifying and selection a media content for playback. For example, a screen scrolling and selection wheel may be used wherein the user scrolls (using the scroll wheel) through a list of media content stored.

Device 100 may have media location and access services 104 provided thereto that are adapted to locate any stored media and provide indication of the stored media on display device 101 for user manipulation. In one instance, stored media selections may be searched for on device 100 by inputting a text query comprising the file name of a desired entry.

Device 105 may have a media content indexing service 105 that is adapted to provide a content listing such as an index of media content selection stored on the device. Such a list may be scrollable and may be displayed on device display 101. Device 100 has a media content storage memory 106 provided thereto, which provides the resident memory space within which the actual media content is stored on the device. In typical art, an index like 105 is displayed on device display 101 at which time a user operating the device may physically navigate the list to select a media content file for execution and display. A problem with device 100 is that if many hundreds or even thousands of media files are stored therein, it may be extremely time consuming to navigate to a particular stored file. Likewise data searching using text may cause display of the wrong files.

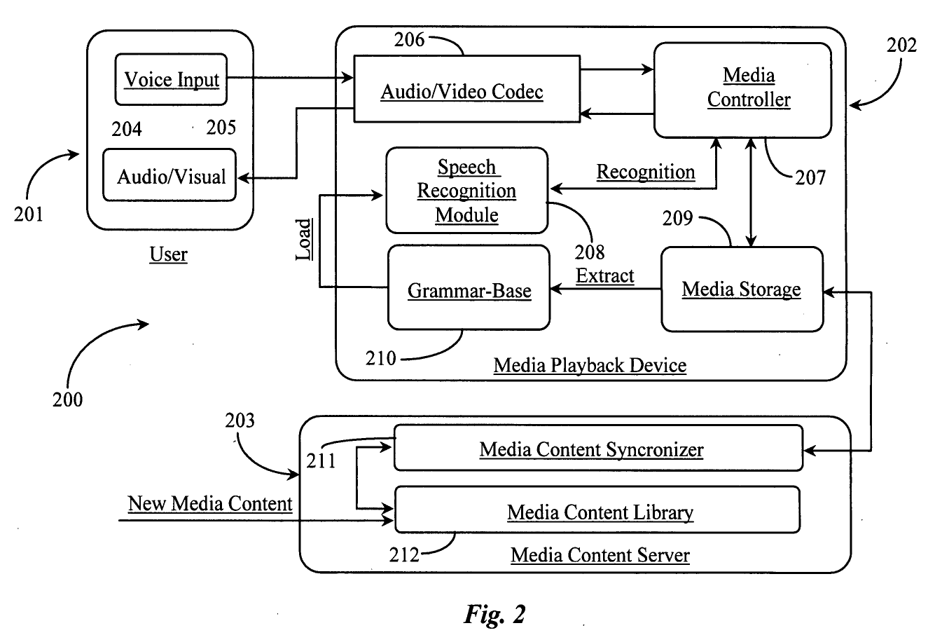

FIG. 2 is a bloc diagram illustrating voice-enabled media content selection system architecture 200 according to an embodiment of the present invention. Architecture 200 includes an entity or user 201, a media playback device 202, and a media content server 203, which may be external to or internal to playback device 202. User 201 is represented herein by two important interaction tasks performed by the user, namely voice input and audio/visual dissemination of content. User 201 may initiate voice input through a device like a microphone or other audio input device. User 201 listens to music and views visual content typically by observing a playback screen (not illustrated) generic to device 202.

Device 202 may be assumed to contain all of the component layers and functions described with respect to device 100 described above without departing from the spirit and scope of the present invention. According to a preferred embodiment of the present invention, device 202 is enhanced for voice recognition, media content location, and command execution based on recognized voice input.

Playback device 202 includes a speech recognition module 208 that is integrated for operation with a media controller 207 adapted to access and to control playback of media content. An audio/video codec 206 is provided within media playback device 202 and is adapted to decode media content and to convert digital content to analog content for playback over an audio speaker or speaker system, and to enable display of graphics on a suitable display screen mentioned above. In a preferred embodiment, codec 206 is further adapted to receive analog voice input and to convert the analog voice input into digital data for use by media controller to access a media content selection identified by the voice input with the aid of speech recognition module 208.

Media playback device 202 includes a media storage memory 209, which may be a robust memory space of more than one gigabyte of memory. A second memory space is reserved for a grammar base 210. Grammar base 210 contains all of the names of the executable media content files that reside in media storage 209. All of the names in the grammar base are loaded into, or at least accessed by the speech recognition module 208 during any instance of voice input initiated by a user with the playback device powered on and set to find media content. There may be other voice-enabled tasks attributed to the system other than specific media content selection and execution without departing from the spirit and scope of the present invention.

Media content server 203 has direct access to media storage space 209. Server 203 maintains a media library that contains the names of all of the currently available selections stored in space 209 and available for playback. A media content synchronizer 211 is provided within server 203 and is adapted to insure that all of the names available in the library represent actual media that is stored in space 209 and available for playback. For example, if a user deletes a media selection and it is therefore no longer available for playback, synchronizer 211 updates media content library 212 of the deletion and the name is purged from the library.

Grammar base 210 is updated, in this case, by virtue of the fact that the deleted file no longer exists. Any change such as deletion of one or more files from or addition of one or more files to device 202 results in an update to grammar base 210 wherein a new grammar list is uploaded. Grammar base 210 may extract the changes from media storage 209, or content synchronizer may actually update grammar base 210 to implement a change. When the user downloads one or more new media files, the names of those selections are updated into media content library 212 and synchronized ultimately with grammar base 210. Therefore, grammar base 210 always has a latest updated list of file names on hand for upload into speech recognition module 208.

As described further above, media server 203 may be an onboard system to media device 202. Likewise, sever 203 may be an external, but connectable system to media playback device 202. In this way, many existing media playback devices may be enhanced to practice the present invention. Once media content synchronization has been accomplished, speech recognition module 208 may recognize any file names uttered by a user.

According to a further enhancement, user 201 may conduct a voice-enabled media search operation whereby generic terms are, by default, included in the vocabulary of the speech recognition module. For example, the terms jazz, rock, blues, hip-hop, and Latin, may be included as search terms recognizable by module 208 such that when detected, cause only file names under the particular genre to be selectable. This may prove useful for streamlining in the event that a user has forgotten the name of a selection that he or she wishes to execute by voice. A voice response module may, in one embodiment, be provided that will audibly report the file names under any particular section or portion of content searched back to the user. Likewise other streamlining mechanisms may be implemented within device 202 without departing from the spirit and scope of the invention such as enabling the system to match an utterance with more than one possibility through syllable matching, vowel matching, or other semantic similarities that may exist between names of media selections. Such implements may be governed by programmable rules accessible on the device and manipulated by the user.

One with skill in the art will recognize that in an embodiment of a remote media server from the playback device, that the synchronization between the playback device media player and the media content server can be conducted through a docking wired connection or any wireless connection such as 2 G, 2.5 G, 3 G, 4 G, WIFI, WIMAX, etc. Likewise, appropriate memory caching may be implemented to media controller 207 and/or audio/video codec 206 to boost media playing performance.

One of skill in the art will also recognize that media playback device 202 might be of any form and is not limited to a standalone media player. It can be embedded as software or firmware into a larger system such as a PDA phone or smart phone or any other system or sub-system.

In one embodiment, media controller 202 is enhanced to handle more complex logics to enable the user 201 to perform more sophisticated media content selection flow such as navigating via voice a hierarchical menu structure attributed to files controlled by media playback device 202. As described further above, certain generic grammar may be implemented to aid navigation experience such as “next song”, “previous song”, the name of an album or channel or the name of the media content list, in addition to the actual media content name.

In still a further enhancement, additional intelligent modules such as the heuristic behavioral architecture and advertiser network modules can be added to the system to enrich the interaction between the user and the media playback device. The inventor knows of intelligent systems for example that can infer what the user really desires based on navigation behavior. If a user says rock and a name of a song, but the song named and currently stored on the playback device is a remix performed as a rap tune, the system may prompt the user to go online and get the rock and roll version of the title. Such functionality can be brokered using a third-party subsystem that has the ability t connect through a wireless or wired network to the user's playback device. Additionally, intelligent modules of the type described immediately above may be implemented on board the device as chip-set burns or as software implementations depending on device architecture. There are many possibilities.

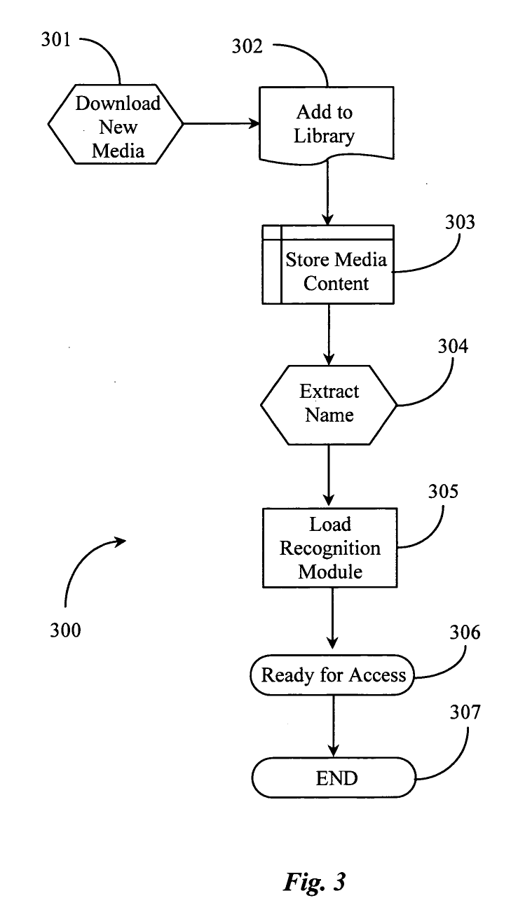

FIG. 3 is a flow chart 300 illustrating steps for synchronizing media with a voice-enabled media server according to an embodiment of the present invention. At step 301, the user authorizes download of a new media content file or file set to the device. At step 302, the media content synchronizer adds the name of the content to the media content library. The name added might be constructed by the user in some embodiments whereby the user types in the name using an input device and method such as may be available on a smart telephone. The synchronizer makes sure that the content is stored and available for playback at step 303. At step 304, the name for locating and executing the content is extracted, in one embodiment from the storage space and then loaded into the speech recognition module by virtue of its addition to the grammar base leveraged by the module. In one embodiment, in step 304, the synchronization module connects directly from the media content library to the grammar base and updates the grammar base with the name.

At step 306, the new media selection is ready for voice-enabled access whereupon the user may utter the name to locate and execute the selection for playback. At step 307, the process ends. The process is repeated for each new media selection added to the system. Likewise, the synchronization process works each time a selection is deleted from storage 209. For example, if a user deletes media content from storage, then the synchronization module deletes the entry from the content library and from the grammar base. Therefore, the next time that the speech recognition module is loaded with names, the deleted name no longer exists and therefore the selection is no longer recognized. If a user forgets a deletion of content and attempts to invoke a selection, which is no longer recognized, an error response might be generated that informs the user that the file may have been deleted.

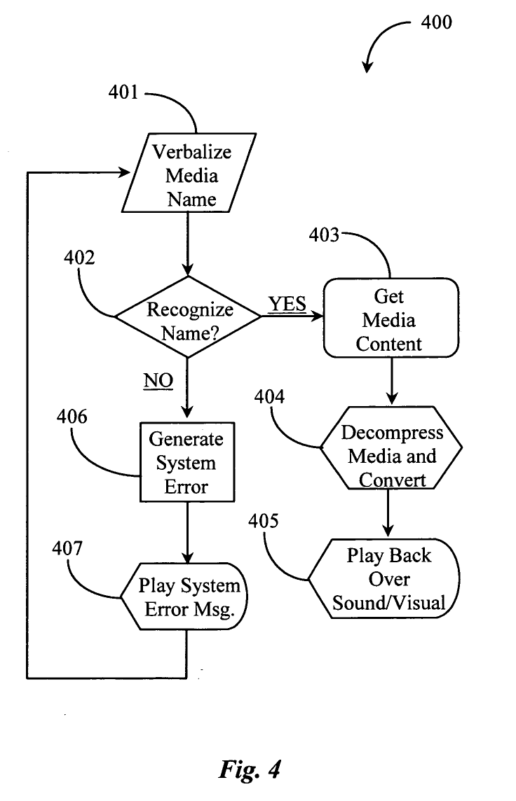

FIG. 4 is a flow chart 400 illustrating steps for accessing and playing synchronized media content according to an embodiment of the present invention. At step 401, the user verbalizes the name of the media selection that he or she wishes to playback. At step 402, the speech recognition module attempts to recognize the spoken name. If recognition is successful at step 402, then at step 403, the system retrieves the media content and executes the content for playback.

At step 404 the content is decompressed and converted from digital to analog content that may be played over the speaker system of the device in step 405. If at step 402, the speech recognition module cannot recognize the spoken file name, then the system generates a system error message, which may be in some embodiments, an audio response informing the user of the problem at step 407. The message may be a generic recording played when an error occurs like “Your selection is not recognized” “Please repeat selection now, or verify its existence”.

The methods and apparatus of the present invention may be adapted to an existing media playback device that has the capabilities of playing back media content, publishing stored content, and accepting voice input that can be programmed to a playback function. More sophisticated devices like smart cellular telephones and some personal digital assistants already have voice input capabilities that may be re-flashed or re-programmed to practice the present invention while connected, for example to an external media server. The external server may be a network-based service that may be connected to periodically for synchronization and download or simply for name synchronization with a device. New devices may be manufactured with the media server and synchronization components installed therein.

The methods and apparatus of the present invention may be implemented with all of some of, or combinations of the described components without departing from the spirit and scope of the present invention. In one embodiment, a service may be provided whereby a virtual download engine implemented as part of a network-based synchronization service can be leveraged to virtually conduct, via connected computer, a media download and purchase order of one or more media selections.

The specified media content may be automatically added to the content library of the user's playback device the next time he or she uses the device to connect to the network. Once connected the appropriate files might be automatically downloaded to the device and associated with the file names to enable voice-enabled recognition and execution of the downloaded files for playback. Likewise, any content deletions or additions performed separately by the user using the device can be uploaded automatically from the device to the network-based service. In this way the speech system only recognizes selections stored on and playable from the device.

Push to Talk Speech Recognition Interface

According to another aspect of the present invention, a voice-enabled media content selection and playback system is provided that may be controlled through synchronous or asynchronous voice command including push-to-talk interaction from one to another component of the device, from the device to an external entity or from an external entity to the device.

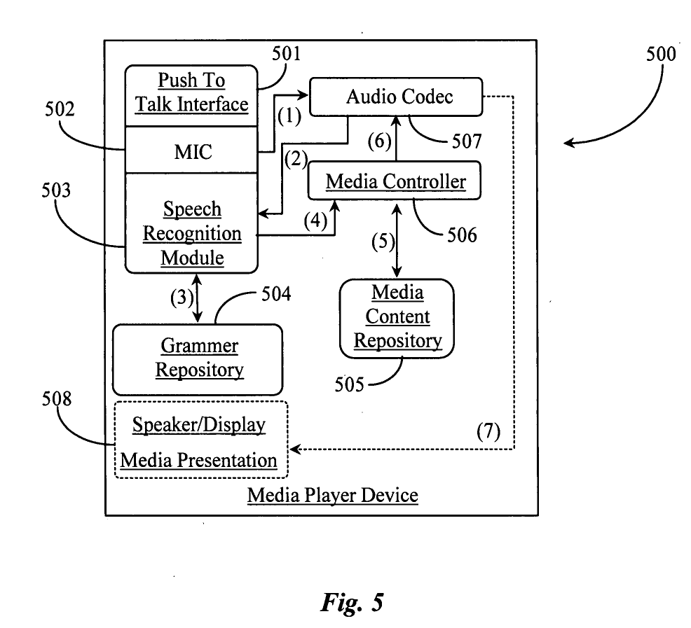

FIG. 5 is a block diagram illustrating a media player 500 enhanced with an onboard push-to-talk interface according to an embodiment of the present invention. Device 500 includes components that may be analogous to components illustrated with respect to the media playback device 202, which were described with respect to FIG. 2 [our docket 8130PA]. Therefore, some components illustrated herein will not be described in great detail to avoid redundancy except where relevant to features or functions of the present invention.

Device 500 may be of the form of a hand-held media player, a cellular telephone, a personal digital assistant (PDA), or other type of portable hand-held player as described previously in [our docket 8130PA]. Likewise, player 500 may be a software application installed on a multitasking computer system like a Laptop, a personal computer (PC), or a set-top-box entertainment component cabled or otherwise connected to a media content delivery network. For the purposes of discussion only, assume in this example that media player device 500 is a hand-operated device.

To illustrated basic function with respect to media selection and playback, device 500 has a media content repository 505, which is adapted to store media content locally, in this case, on the device. Repository 505 may be robust and might contain media selections of the form of audio and/or audio/visual description, for example, songs and movie clips. In this example, device 500 includes a grammar repository 504, which as previously described in detail with respect to [our docket 8130PA]. Repository 504 serves as a directory or library of grammar sets that may be used as descriptors for invoking media content through voice recognition technology (VRT). To this end, device 500 includes a speech recognition module (SRM) 503, and a microphone (MIC) 502.

In this example, a media controller 506 is provided for retrieving media contents from content repository 505 in response to a voice command recognized by SRM 503. The retrieved contents are then streamed to an audio or audio/video codec 507, which is adapted to convert the digital content to analog for play back over a speaker/display media presentation system 508.

In this example, a push-to-talk interface feature 501 is provided on device 500 and is adapted to enable an operator of the device to enable a unilateral voice command to be initiated for the express purpose of selecting and playing back a media selection from the device. Interface 501 may be provided as a circuitry enabled by a physical indicia such as a push button. A user may depress such a button and hold it down to turn on microphone 502 and utter a speech command for selection and playback execution of media stored, in this case, on the device.

This example assumes that media content repository 505 is in sync with grammar repository 504 so that any voice command uttered is recognized and the media selected is in fact available for playback. Moreover, a media content server including content synchronizer and content library such as were described in [our docket 8130PA] FIG. 2 may be present for media content synchronization of device 500 as was described with respect to FIG. 2 above and therefore may be assumed to applicable to device 500 as well.

At act (1), a user may depress interface 501, which automatically activates MIC 502, and utters a command for speech recognition. The command is converted from analog to digital in codec 507 and then loaded into SRM 503 at act (2). SRM 503 then checks the command against grammar repository 504 for a match at act (3). Assuming a match, SRM 503 notifies media controller 506 in act (4) to get the media identified for playback from content repository 505 at act (5). The digital content is streamed to codec 507 in act (6) whereby the digital content is converted to analog content for audio/visual playback. At act (7) the content plays over media presentation system 508 and is audible and visible to the operating user.

In this embodiment, the push-to-talk feature is used to select content for playback, however that should not be construed as a limitation for the feature. In one embodiment, the feature may also be used to interact with external systems for both media content/grammar repository synchronization and acquisition and synchronization of content with an external system as will be described further below.

It will be apparent to one with skill in the art that the commands uttered may equate 1-to-1 with known media selection for playback such that by saying a title, for example, results in playback execution of the selection having that title. In one embodiment, more than one selection may be grouped under a single command in a hierarchical structure so that all of the selections listed under the command are activated for continuous serial playback whenever that command is uttered until all of the selections in the group or list have been played. For example, a user may utter the command “Jazz” resulting in playback of all of the jazz selections stored on the device and serially listed in a play list, for example, such that ordered playback is achieved one selection at a time. Selections invoked in this manner may also be invoked individually by title, as sub lists by author, or by other pre-planned arrangement.

Because device 500 has an onboard push-to-talk interface, no music or other sounds are heard from the device while commands are being delivered to SRM 503 for execution. Therefore, if a song is currently playing back on device 500 when a new command is uttered, then by default the playback of the previous selection is immediately interrupted if the new command is successfully recognized for playback of the new selection. In this case, the current selection is abandoned and the new selection immediately begins playing. In another embodiment, SRM 503 is adapted with the aid of grammar repository 504 to recognize certain generic commands like “next song”, “skip”, “search list” or “after current selection” to enable such as song browsing within a list, skipping from one selection to the next selection, or even queuing a selection to commence playback only after a current selection has finished playback. There are many possibilities.

In one embodiment, interface 501 may be operated in a semi background fashion on a device that is capable of more than one simultaneous task such as browsing a network, or accessing messages, and playing music. In this case, depressing the push-to-talk command interface 501 on device 500 may not interrupt any current tasks being performed by device 500 unless that task is playing music and that task is interrupted by virtue of a successfully recognized command. In one embodiment, the nature of the command coupled with the push-to-talk action performed using feature 501 functions similarly to emulate command buttons provided on a compact disk player or the like. The feature allows one button to be depressed and the voice command uttered specifies the function of the ordered task. Mute, pause, skip forward, skip backward, play first, play last, repeat, skip to beginning, next selection, and other commands may be integrated into grammar repository 505 and assigned to media controller function without departing from the spirit and scope of the present invention.

In another embodiment, push to talk feature 501 may be dedicated solely for selecting and executing playback of a song while SRM 503 and MIC 502 may be continuously active during power on of device 500 for other types of commands that the device might be capable of such as “access email”, “connect to network”, or other voice commands that might control other components of device 500 that may be present but not illustrated in this example.

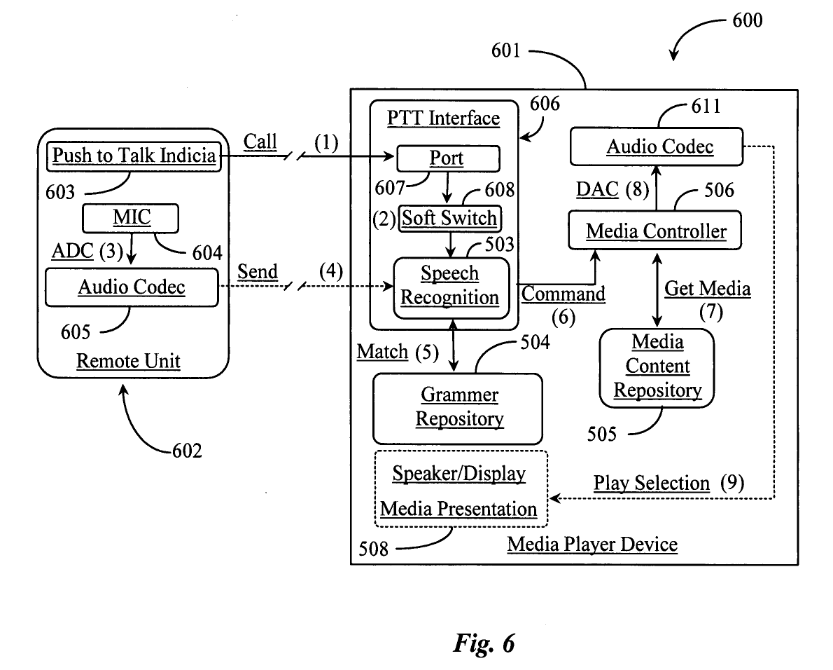

FIG. 6 is a block diagram illustrating a media playback device 600 enhanced with a push to talk feature according to another embodiment of the present invention. Device 600 has many of the same components described with respect to device 500 of FIG. 5. Those components that are the same shall have the same element number and shall not be re-introduced. In this embodiment, device 600 is controlled remotely via use of a remote unit 602. Remote unit 602 may be a dedicated push to talk remote device adapted to communicate via a wireless communication protocol with device 600 to enable voice commands to be propagated to device 600 over the wireless link or network.

In this example, device 600 has a push to talk interface 606, adapted as a soft feature controlled from a peripheral device or a remote device. In this example, device 600 may be a set-top-box system, a digital entertainment system, or other system or sub system that may be enhanced to receive commands over a network from an external device. Interface 606 has a communications port 607, which contains all of the required circuitry for receiving voice commands and data from remote unit 602. Interface 606 has a soft switch 608 that is adapted to establish a push to talk connection detected by port 607, which is adapted to monitor the prevailing network for any activity from unit 602. The only difference between this example and the example of FIG. 5 is that in this case the physical push-to-talk hardware and analog to digital conversion of voice commands is offloaded to an external device such as unit 602.

Unit 602 includes minimally, a push to talk indicia or button 603, a microphone 604, and an analog to digital codec 605 adapted to convert the analog signal to digital before sending the data to device 600. There is no geographic limitation as to how far away from device 600 unit 602 may be deployed. In one embodiment, unit 602 is similar to a wireless remote control device capable of receiving and converting audio commands into the digital commands. In such an embodiment, Wireless Fidelity (WiFi), Bluetooth™, WiMax, and other wireless network may be used to carry the commands.

A user operating unit 602 may depress push-to-talk indicia 603 resulting in a voice call in act (1), which may register at port 607. When port 607 recognizes that a call has arrived, it activates soft switch 608 in act (2) to enable media content selection and playback execution. The user utters the command using MIC 604 with the push-to-talk indicia depressed. The voice command is immediately converted from analog to digital by an analog to digital (ADC) audio codec 605 provided to unit 602 for send at act (4) over the push to talk channel. The prevailing network may be a wireless network to which both device 600 and unit 602 are connected.

In this example, SRM 503 receives the command wirelessly as digital data at act (4) and matches the command against commands stored in grammar repository 504 at act (5). Assuming a match, SRM 503 notifies media controller 506 at act (6) to retrieve the selected media from media content repository 505 at act (7) for playback. Media controller 506 streams the digital content to a digital-to-audio/visual DAC audio codec 611 at act (8) and the selection is played over media presentation system 508 in act (9). This embodiment illustrates one possible variation of a push to talk feature that may be used when a user is not necessarily physically controlling or within close proximity to device 600.

To illustrate one possible and practical use case, consider that device 600 is an entertainment system that has a speaker system wherein one or more speakers are strategically placed at some significant distance from the playback device itself such as in another room or in some other area apart from device 600. Without remote unit 602, it may be inconvenient for the user to change selections because the user would be required to physically walk to the location of device 600. Instead, the user simply depresses the push-to-talk indicia on unit 602 and can wirelessly transmit the command to device 600 and can do so from a considerable distance away from the device over a local network. In one embodiment, a mobile user may initiate playback of media on a home entertainment system, for example, by voicing a command employing unit 602 as the user is pulling into the driveway of the home.

In one possible embodiment, device 600 may be a stationary entertainment system and not a mobile or portable system. Such a system might be a robust digital jukebox, a TiVo™ recording and playback system, a digital stereo system enhanced for network connection, or some other robust entertainment system. Unit 602 might, in this case, be a cellular telephone, a Laptop computer, a PDA, or some other communications device enhanced with the capabilities of remote unit 602 according to the present invention. The wireless network carrying the push-to-talk call may be a local area network or even a wide area network such as a municipal area network (MAN).

In such as case, a user may be responsible for entertainment provided by the system and enjoyed by multiple consumers such as coworkers at a job site; shoppers in a department store; attendees of a public event; or the like. In such an embodiment, the user may make selection changes to the system from a remote location using a cellular telephone with a push to talk feature. All that is required is that the system have an interface like interface 606 that may be called from unit 602 using a “walkie talkie” style push to talk feature known to be available for communication devices and supported by certain carrier networks.

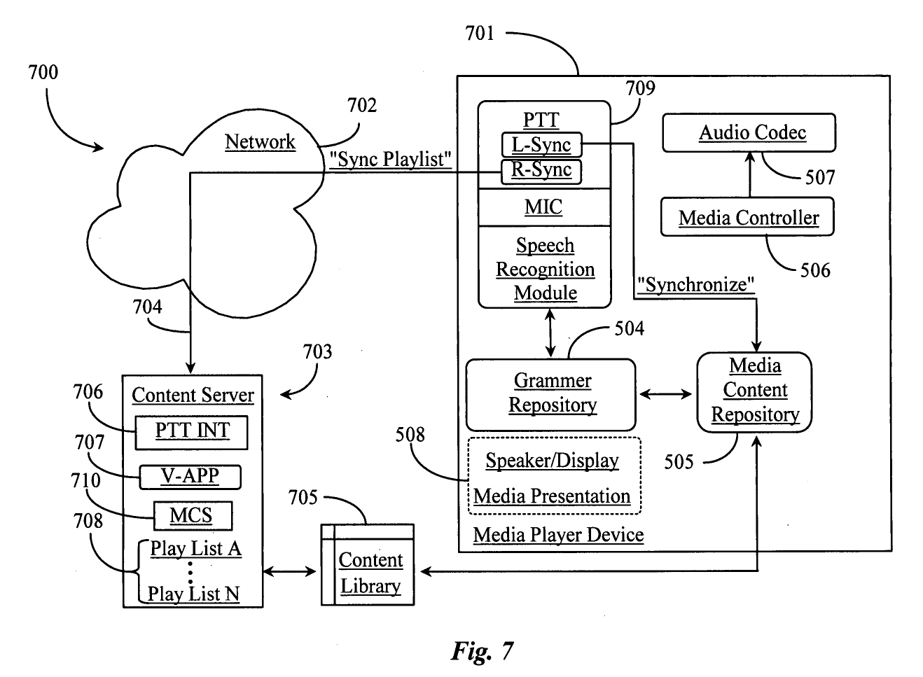

FIG. 7 is a block diagram illustrating a multimedia communications network 700 bridging a media player device 701 and a content server 703 according to an embodiment of the present invention. Network 700 includes a communications carrier network 702, a media player device 701, and a content server 703. Network 702 may be any carrier network or combination thereof that may be used to propagate digital multimedia content between device 701 and server 703. Network 702 may be the Internet network, for example, or another publicly accessible network segment.

Device 701 is similar in description to device 500 of FIG. 5 accept that in this example, a push to talk feature 709 is provided and adapted to enable content synchronization both on a local level and on a remote level according to embodiments of the present invention. In one embodiment device 701 is also capable of push-to-talk media selection and playback as described above in the description of FIG. 5. In this embodiment, a user operating from device 701 may synchronize content stored on the device with a remote repository using push-to-talk voice command. Likewise, a manual push-to-talk task may be employed for local device synchronization of content such as media repository to grammar repository synchronization.

To perform a local synchronization (current media items to grammar sets) between repository 505 and grammar repository 504, a user simply depresses a push-to-talk local synchronization (L-Sync) button provided as an option on push to talk feature 709. The purpose of this synchronization task is to ensure that if a media selection is dropped from repository 505, that the grammar set invoking that media is also dropped from the grammar repository. Likewise if a new piece of media is uploaded into repository 505, then a name for that media must be extracted and added to grammar repository 504. It is clear that many media selections may be deleted from or uploaded to device 701 and that manual tracking of everything can be burdensome, especially with robust content storage capabilities that exist for device 701. Therefore the ability to perform a sync operation streamlines tasks related to configuring play lists and selections for eventual playback.

A user may at any time depress L-sync to initiate a push-to-talk voice command to media content repository 505 (local on the device) telling it to synchronize its current content with what is available in the grammar repository. Once this is accomplished, the user may now use push-to-talk to order perform a local sync on the device between selections in the media content repository and selection titles or other commands identifying them in grammar repository 504. The L-Sync PTT event sends a command to the media content repository to sync with the grammar repository . Repository 505 then syncs with grammar repository 504 and is finished when all of the correct grammar sets can be used to successfully retrieve the correct media stored. In this way no matter what changes repository 505 undergoes with respect to its contents, the current list of contents therein will always be known and SRM 504 can be sure that a match occurs before attempting to play any music.

In one embodiment, depressing a dedicated button on the device performs synchronizing between content repository 505 and grammar repository 504. In this case it is not necessary to utter voice a command such as “synchronize”. However, in a preferred embodiment, the same push to talk interface indicia may be used to both select media and to synchronize between content repository and a local grammar repository for voice recognition purposes. In this case, the voice command determines which component will perform the task, for example, saying a media title recognized by the SRM will invoke a media selection, the action performed by the media controller, whereas locally synchronizing between media content and grammar sets may be performed by the grammar repository or the media content repository, or by a dedicated synchronizer component similar to the media content synchronizer described further above in this specification.

Server 703 is adapted as a content server that might be part of an enterprise helping their users experience a trouble free music download service. Server 703 also has a push-to-talk interface 706, which may be controlled by hard or soft switch. For remote sync operations it is important to understand that the user might be syncing stored content with a “user space” reserved at a Web site or even a music download folder stored at a server or on some other node accessible to the user. In one embodiment the node is a PC belonging to the user that user uses device 701 and push to talk function to perform a PC “sync” to synchronize media content to the device.

Content server 703 has a push to talk interface 706 provided thereto and adapted as controllable via soft switch or hard switch. In this example, server 703 has a speech application 707 provided thereto and adapted as a voice interactive service application that enables consumers to interact with the service to purchase music using voice response. In this regard, the application may include certain routines known to the inventor for monitoring consumer navigation behavior, recorded behaviors, and interaction histories of consumers accessing the server so that dynamic product presentations or advertisements may be selectively presented to those consumers based on observed or recorded behaviors. For example, if a consumer contacts server 703 and requests a blues genre, and a history of interaction identifies certain favorite artists, the system might advertise one or more new selections of one of the consumer's favorite artists the advertisement dynamically inserted into a voice interaction between the server and the consumer.

Server 703 includes, in this example, a media content library 705, which may be analogous to library 212 described with reference to FIG. 2 in [our docket 8130PA] and a media content synchronizer (MCS) 710, which may be analogous to media content synchronizer 211 also described with reference to FIG. 2 of the same reference. In this example, media content available from server 703 is stored in content library 705, which may be internal to or external from the server. In one embodiment, server 703 may include personal play lists 708 that a consumer has access to or has purchased the rights to listen to. In this case, play lists 708 include list A through list N. A play list may simply be a list of titles of music selections or other media selections that a user may configure for defining downloaded media content to a device analogous to device 701. For example, music stored on device 701 may be changed periodically depending on the mood of the user or if there is more than one user that shares device 701. A play list may be categorized by genre, author, or by some other criterion. The exact architecture and existence of personalized play lists and so on depends on the business model used by the service.

In this example, a user operating device 701 may perform a push to talk action for remote sync of media content by depressing the push to talk indicia R-Sync. This action may initiate push to talk call to the server over link 704 whereupon the user may utter, “sync play lists” to device 701 for example. The command is recognized at the PTT interface 706 and results in a call back by the server to device 701 or an associated repository for the purpose of performing the synchronization. It is important to note herein that a push to talk call placed by device 701 to such as an external service may be associated with a telephone number or other equivalent locating the server. Push-to-talk calls for selecting media content for playback may not invoke a phone call in the traditional sense if the called component is an on-board device. Therefore, a memory address or bus address may be the equivalent. Moreover a device with a full push-to-talk feature may leverage only one push to talk indicia whereupon when pressed, the recognized voice command determines routing of the event as well as the type of event being routed.

The call back may be in the form of a server to device network connection initiated by the server whereby the content in repository 505 may be synchronized with remote content in library 705 over the connection. To illustrate a use case, a user may have authorized monthly automatic purchases of certain music selections, which when available are locally aggregated at a server-side location by the service for later download by the user. An associated play list at the server side may be updated accordingly even though device 701 does not yet have the content available. A user operating device 701 may initiate a push to talk call from the device to the server in order to start the synchronization feature of the service. In this case the device might be a cellular telephone and the server might be a voice application server interface. In the process, device 701 may be updated with the latest selections in content library downloaded to repository 505 over the link established after the push to talk call was received and recognized at the server. If there is true synchronization desired between library and repository 505 then anything that was purged from one would be purged from the other and anything added to one would be added to the other until both repositories reflected the exact same content. This might be the case if library is an intermediate storage such as a user's personal computer cache and the computer might synchronize with the player.

After a remote sync operation is completed, a local sync operations needs to be performed so that the grammar sets in grammar repository 504 match the media selections now available in content repository 505 for voice-activated playback. Content server 703 may be a node local to device 701 such as on a same local network. In one embodiment, content server 703 may be external and remote from the player device. In one preferred embodiment, media content server 703 is a third party proxy server or subsystem that is enabled to synchronize media content between any two media storage repositories such as repository 505 and content library 705 wherein the synchronization is initiated from the server. In such a use case, a user owning device 701 may have agreed to receive certain media selections to sample as they become available at a service.

The user may have a personal space maintained at the service into which new samples are placed until they can be downloaded to the user's player. Periodically, the server connects to the personal library of the user and to the player operated by the user in order to ensure that the latest music clips are available at the player for the user to consume. Alerts or the like may be caused to automatically display to the user on the display of the device informing the user that new clips are ready to sample. The user may “push to talk” uttering “play samples” causing the media clips to load and play. Part of the interaction might include a distributed voice application module which may enable the user to depress the push to talk button again and utter the command “purchase and download”, if he or she wants to purchase a selection sample after hearing the sample on the device.

In the above example, the device would likely be a cellular telephone or other device capable of placing a push to talk call to the service to “buy” one or more selections based on the samples played. The push to talk call received at the server causes the transaction to be completed at the server side, the transaction completed even though the user has terminated the original unilateral connection after uttering the voice command. After the transaction is complete, the server may contact the media library at the server and the player device to perform the required synchronization culminating in the addition of the selections to the content repository used by the media player. In this way bandwidth is conserved by not keeping an open connection for the entire duration of a transaction thus streamlining the process. It is important to note herein that a push to talk call from a device to a server must be supported at both ends by push to talk voice-enabled interfaces.

In one embodiment, the service aided by server 703 may, from time to time, initiate a push to talk call to a device such as device 701 for the purpose of real time alert or update. This such as case, some new media selections have been made available by the service and the service wants to advertise the fact more proactively than by simply updating a Web site. The server may initiate a push-to-talk call to device 701, or quite possibly a device host, and wherein the advertisement simply informs the user of new media available for download and, perhaps pushes one or more media clips to the device or device host through email, instant message, or other form of asynchronous or near synchronous messaging. Device 701 may, in one embodiment, be controlled through voice command by a third party system wherein the system may initiate a task at the device from a remote location through establishing a push to talk call and using synthesized voice command or a pre-recorded voice command to cause task performance if authorization is given to such a system by the user. In such a case, a system authorized to update device 701 may perform remote content synchronization and grammar synchronization locally so that a user is required only to voice the titles of media selections currently loaded on the device.

To illustrate the above scenario, assume that a user has purchased a device like device 701 and that a certain period of free music downloads from a specific service was made part of the transaction. In this case, the service may be authorized to contact device 701 and perform initial downloads and synchronization, including loading grammar sets for voice enabled playback execution of the media once it has been downloaded to the device from the service. During a time period, the user may purchase some or all of the selections in order to keep them on the device or to transfer them to another media. After an initial period, the service may replace the un-purchased selections on the device with a new collection available for purchase. Play lists of titles may be sent to the user over any media so that the user may acquaint him or herself to the current collection on the device by title or other grammar set so that voice-enabled invocation of playback can be performed locally at the device. There are many possible use cases that may be envisioned.

The methods and apparatus of the invention may be practiced in accordance with a wide variety of dedicated or multi-tasking nodes capable of playing multimedia and of data synchronization both locally and over a network connection. While traditional push-to-talk methods imply a call placed from one participant node to another participant node over a network whereupon a unilateral transference of data occurs between the nodes, it is clear according to embodiments described that the feature of the present invention also includes embodiments where a participant node may be equated to a component of a device and the calling party may be a human actor operating the device hosting the component.

The present invention may be practiced with all or some of the components described herein in various embodiments without departing from the spirit and scope of the present invention. The spirit and scope of the invention should be limited only by the claims, which follow.

What is claimed is:

1. A system enabling voice-enabled selection and execution for playback of media files stored on a media content playback device comprising:
a voice input circuitry and speech recognition module for enabling voice input recognizable on the device as one or more voice commands for task performance;
a push-to-talk interface for activating the voice input circuitry and speech recognition module; and
a media content synchronization device for maintaining synchronization between stored media content selections and at least one list of grammar sets used for speech recognition by the speech recognition module, the names identifying one or more media content selections currently stored and available for playback on the media content playback device.

2. The system of claim 1, wherein the playback device is a digital media player, a cellular telephone, or a personal digital assistant.

3. The system of claim 1, wherein the playback device is a Laptop computer, a digital entertainment system, or a set top box system.

4. The system of claim 1, wherein the push-to-talk interface is controlled by physical indicia present on the media content playback device.

5. The system of claim 1, wherein a soft switch controls the push-to-talk interface, the soft switch activated from a remote device sharing a network with the media content playback device.

6. The system of claim 1, wherein the names in the grammar list define one or a combination of title, genre, and artist associated with one or more media content selections.

7. The system of claim 1, wherein the media content selections are one or a combination of songs and movies.

8. The system of claim 1, wherein the media content synchronization device is external from the media content playback device but accessible to the device by a network.

9. The system of claims 5 and 8 wherein the network is one of a wireless network bridged to an Internet network.

10. The system of claim 1, further comprising:
a voice-enabled remote control unit for remotely controlling the media content playback device.

11. The system of claim 10, wherein the remote unit includes a push-to-talk interface, voice input circuitry, and an analog to digital converter.

12. A server node for synchronizing media content between a repository on a media content playback device and a repository located externally from the media content playback device comprising:
a push-to-talk interface for accepting push-to-talk events and for sending push-to-talk events;
a multimedia storage library; and
a multimedia content synchronizer.

13. The server node of claim 12, wherein the server is maintained on an Internet network.

14. The server node of claim 12 wherein the server node includes a speech application for interacting with callers, the application capable of calling the playback device and issuing synthesized voice commands to the media content playback device.

15. The server of claim 14, wherein the call placed through the speech application is a unilateral voice event, the voice synthesized or pre-recorded.

16. A media content selection and playback device including:
a voice input circuitry for inputting voice commands to the device;
a speech recognition module with access to a grammar repository for providing recognition of input voice commands; and,
a push-to-talk indicia for activating the voice input circuitry and speech recognition module;
wherein depressing the push-to-talk indicia and maintaining the depressed state of the indicia enables voice input and recognition for performing one or more tasks including selecting and playing media content.

17. The device of claim 16, wherein the grammar repository contains at least one list of names defining one or a combination of title, genre, and artist associated with one or more media content selections.

18. The device of claim 17, wherein the grammar repository is periodically synchronized with a media content repository, synchronization enabled through voice command through the push-to-talk interface.

19. A method for selecting and playing a media selection on a media playback device including acts for;
(a) depressing and holding a push to talk indicia on or associated with the playback device;
(b) inputting a voice expression equated to the media selection into voice input circuitry on or associated with the device;
(c) recognizing the enunciated expression on the device using voice recognition installed on the device;
(d) retrieving and decoding the selected media; and
(e) playing the selected media over output speakers on the device.

20. The method of claim 19, wherein steps (a) and (b) are practiced using a remote control unit sharing a network with the device.
